(19) United States
(12) Patent Application Publication
(10) Pub. No.: US 2006/0267718 A1
(43) Pub. Date: Nov. 30, 2006

(54) Microelectronic inductor with high inductance magnetic core

(75) Inventors: Islam A. Salama, Chandler, AZ (US); Cengiz A. Palanduz, Chandler, AZ (US); Mostafa Naguib Abdulla, Rancho Cordova, CA (US); Scott Sahaida, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/137,906

(22) Filed: May 25, 2005

(51) Int. Cl. H01F 5/00

(52) U.S. Cl. 336/200

(57) ABSTRACT

A microelectronic inductor, a method of fabricating the inductor, and a system incorporating the inductor. The inductor comprises a pair of supporting layers; a high inductance soft magnetic core disposed between the supporting layers; and conductive windings provided about the magnetic core, the windings including a system of interconnected conductive vias and conductive traces, the vias extending through the supporting layers and the magnetic core and the conductive traces being disposed to interconnect the vias. The inductor may be discrete or embedded into a substrate by being patterned thereon.

### FIELD

Embodiments of the present invention relate to the field of microelectronic inductor fabrication. More specifically, embodiments of the present invention relate to the field of thin form factor inductors.

### BACKGROUND

The requirement of smaller, more complex, and faster devices operating at high frequencies, such as flash memory PSIP or RF applications, embedded transformers and other power supply applications, has also resulted in an increased demand for small size inductors with high inductance. Small devices such as those noted above require small size inductors, or thin form factor inductors, with high inductance for use in flash devices, resonator circuits, filters, and switch regulators. Thin form factor inductors having high inductances according to the prior art typically have a thickness range between about 100 microns to about 300 microns and an inductance in the range from about 1 nano-Henry to about 1 micro-Henry.

One attempt to satisfy the demand for the thin form factor inductors with a high inductance discussed above has been to integrate or embed the inductor on a substrate that houses a chip. Inductors with an inductance on the order of 1.0 to 3.0 nH, and even as high as 10.0 nH can be embedded on a substrate that houses a chip. An example of an embedded inductor as used in the prior art would include a patterned two-dimensional spiral embedded copper inductor having a core made of Fe or Co. Another attempt to satisfy the demand for inductors with a small size and high inductance has been to use discrete inductors. However, to the extent that current inductors have a thickness above 5 mils or 125 microns, whether embedded or discrete, such inductors disadvantageously tend to add to the size of the resulting package.

Additionally, existing thin form factor inductors, that is, existing inductors having a thickness less than about 300 microns, have an inductance that is still disadvantageously low, that is, between about 1 nano-Henry and about 1 micro-Henry.

There exists a need for a thin form factor inductor having a higher inductances and lower thicknesses than inductors of the prior art in order to accommodate the need for ever shrinking microelectronic packages.

### BRIEF DESCRIPTION OF THE DRAWINGS

Embodiments of the invention are illustrated by way of example and not by way of limitation in the figures of the accompanying drawings, in which the like references indicate similar elements and in which:

FIG. 1 is a schematic representation in partial cross-section of a thin form factor discrete inductor (TFFDI) in a die stack up according to one embodiment;

FIG. 2 is a schematic representation in partial cross-section of the TFFDI shown in FIG. 1;

FIG. 3 is a schematic representation in partial cross-section of a thin form factor embedded inductor (TFFEI) according to a first embodiment;

FIG. 4 is a schematic representation in partial cross-section of a TFFEI according to a second embodiment;

FIGS. 5a-5c are schematic partially cut away top views of three different inductor embodiments, whether TFFDI or TFFEI, according to the present invention;

FIGS. 6a-6i are schematic representations in partial cross-section of stages of forming a TFFDI, such as the TFFDI of FIG. 2;

FIGS. 7a-7m are schematic representations in partial cross-section of stages of forming a TFFEI, such as the TFFEI of FIG. 3;

FIGS. 8a-8b are schematic representations of two laser drilling arrangements adapted to drill via holes in either a TFFDI or a TFFEI according to two embodiments of the present invention; and

FIG. 9 is a schematic representation of a system incorporating either a TFFDI or a TFFEI according to embodiments of the present invention.

### DETAILED DESCRIPTION

A microelectronic inductor, a method of fabricating the inductor, and a system incorporating the inductor are described herein.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

The phrase “in one embodiment” is used repeatedly. The phrase generally does not refer to the same embodiment, however, it may. The terms “comprising”, “having” and “including” are synonymous, unless the context dictates otherwise. In addition, it is noted that, by “partial cross-section” as mentioned with respect to a description of FIGS. 1-4 and 6a-7m herein, what is meant is that the coils of the inductor and/or the metallization lines corresponding to the coils of the inductor being shown are depicted in perspective view, while all other layers are depicted in cross-sectional view.

Referring now to the partial cross-sectional depiction of FIG. 1, a thin form factor discrete inductor (TFFDI) 110 according to a first embodiment of the present invention is shown in a microelectronic arrangement such as a die stack-up 100 as sandwiched between a number of dies 112 placed on a substrate 116. The TFFDI and dies are in electrical communication with substrate 116 through wire-bonds 118.

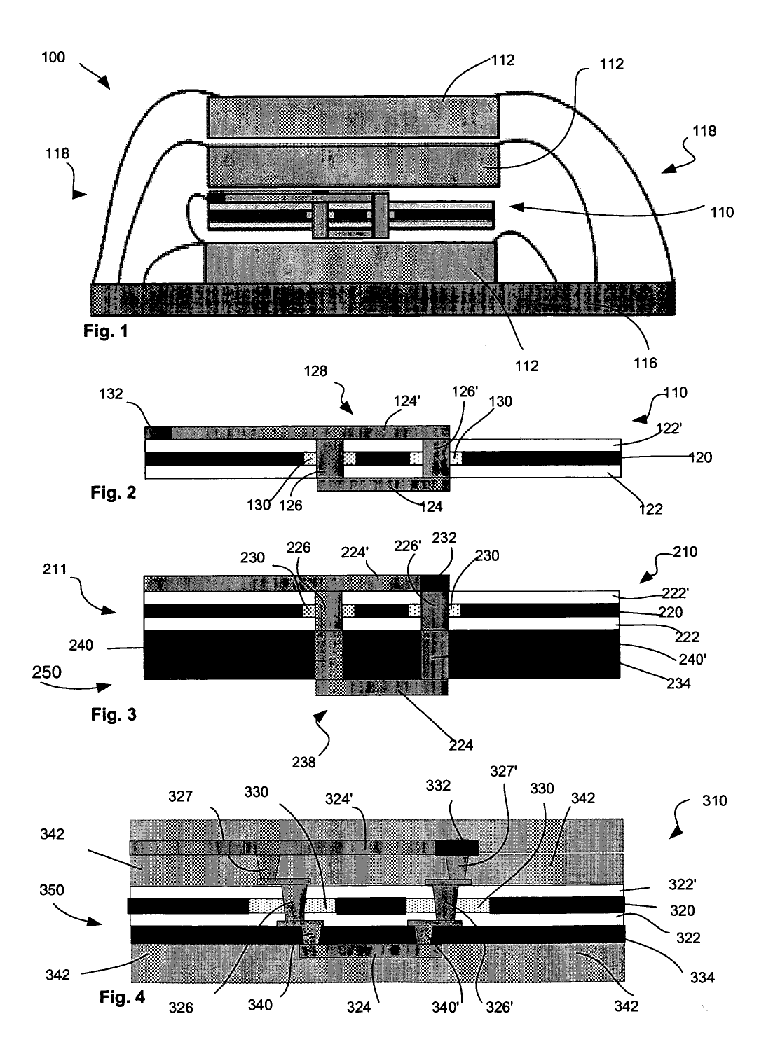

Referring next to FIG. 2, a more detailed view of the TFFDI 110 is provided. TFFDI 110 includes a high inductance magnetic core (HIMC) 120 sandwiched between two supporting layers, in the shown embodiment in the form of two pre-impregnated layers 122 and 122′. The HIMC, may, according to some embodiments, be made of iron, cobalt or nickel, or alloys thereof. The HIMC may further have an inductance that is tunable from the pico Henry to micro Henry range. Pre-impregnated layers 122 and 122′ may include a reinforced polymer, such as, for example, an epoxy based polymer reinforced with glass fibers and filled with silica particles, other similar materials for pre-impregnated layers 122 and 122′ being within the knowledge of a person skilled in the art. A function of the pre-impregnated layers is to serve as additional build-up layers of the package. According to embodiments of the present invention, coil windings for the TFFDI are provided by a system of conductive traces, such as traces 124 and 124′, and vias, such as vias 126 and 126′, which collaborate to form windings 128 about the magnetic core 120, as suggested by way of example in FIG. 2. The traces and vias may include a conductive material such as copper. Spaces may be provided between the vias and the HIMC to isolate the vias from the HIMC. Such spaces may include an electrically insulating material 130 therein, such a, for example, B-stage paste in the form of solder paste.

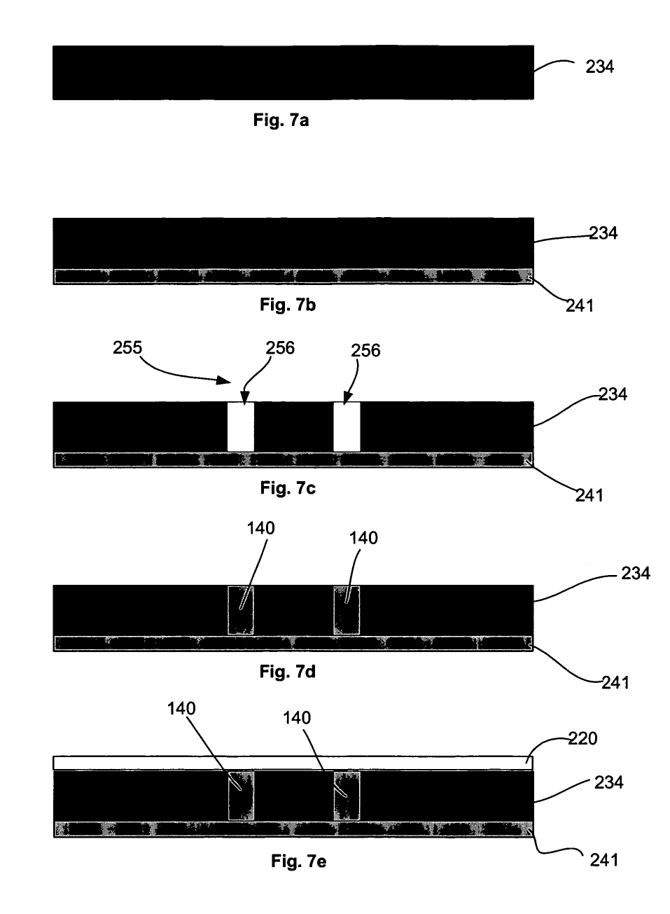

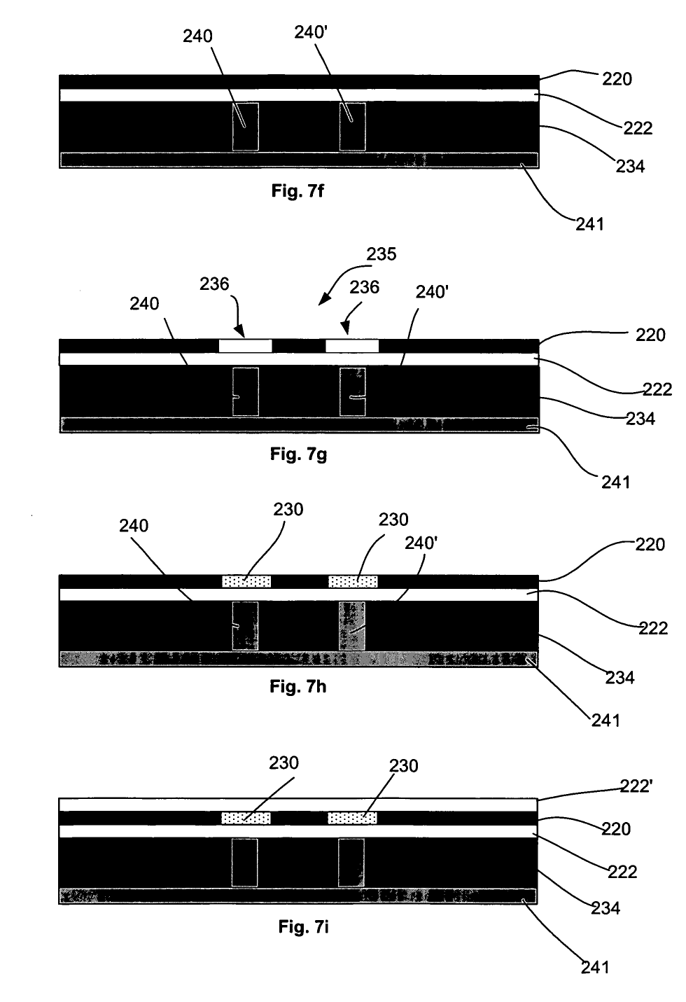

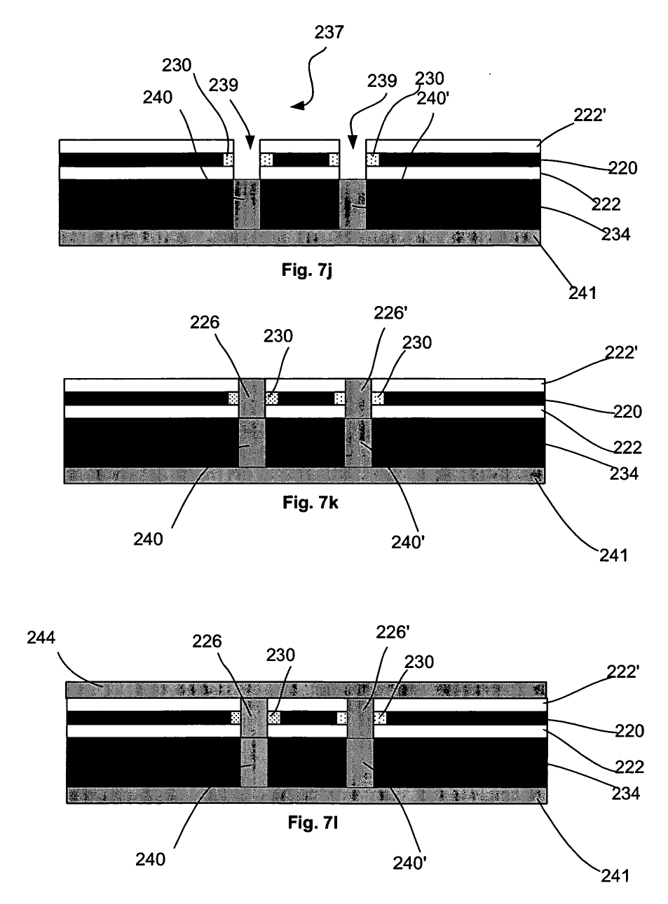

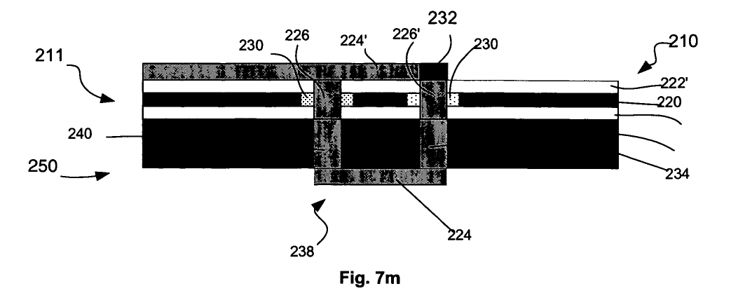

Referring now to FIG. 3, a view similar to FIG. 2 is shown of second embodiment of the present invention, which includes a thin form factor embedded inductor (TFFEI) 210 that is part of a microelectronic assembly 211. TFFEI 210 is similar to TFFDI 110 in structure, except that the coil windings of TFFEI 210 encompass a substrate 234 similar to substrate 116. A device such as a flash device or a voltage regulator may then be connected to the embedded inductor in a known manner, other devices being within the scope of embodiments. The embedding occurs by patterning the inductor on the substrate, as will be described in further detail in relation to FIGS. 7a-7m. As seen in FIG. 3, TFFEI 210 may further include a high inductance magnetic core (HIMC) 220 sandwiched between two supporting layers in the form of dielectric layers 222 and 222′. Similar to HIMC 120 of FIG. 2, HIMC 220, may, according some embodiments, be made of iron, cobalt or nickel, or alloys thereof. According to embodiments of the present invention, the HIMC may have an inductance that is tunable from the pico Henry to the micro Henry range. The dielectric layers may be composed of an organic material, such as, for example, porous or non-porous polymers. Examples for the dielectric layers may include ABF (Ajinomoto Build-Up Film), poly-tetrafluoro ethylene (PTFE), polyimide, low-k materials like SiLK, (Manufacturer: The Dow Chemical Company, Midland, Mich.), poly arylenes, cyclotenes, and teflons, and/or polyimide nanofoams. According to embodiments of the present invention, similar to the coil windings for the TFFDI described above, coil windings 228 of TFFEI 210 may be provided by a system of conductive traces, such as traces 224 and 224′, and vias, such as vias 226 and 226′, that collaborate with vias provided in the device adapted to use the TFFEI, such as vias 240 and 240′ of device 250, as suggested by way of example in FIG. 3. The traces and vias may include a conductive material such as copper. Similar to the TFFDI of FIG. 2, spaces may be provided between the vias 226 and 226′ and the HIMC of the TFFEI to isolate the vias from the same. Such spaces may include an electrically insulating material 230 therein, such as, for example, B-stage paste in the form of solder paste.

FIG. 4 shows a further embodiment of a TFFEI according to the present invention. As seen in FIG. 4, an embodiment 310 of a TFFEI embedded as part of a device 350 may include windings that are made of a system of traces and staggered vias as shown. Thus, where the TFFEI in the embodiment of FIG. 3 shows the vias as extending in straight manner, the TFFEI in the embodiment of FIG. 4 shows the vias as extending in a staggered manner, that is, in a manner that is staggered going from one layer to a subsequent layer of material. Thus, as seen in FIG. 4, similar to TFFEI 210, TFFEI 310 includes a high inductance magnetic core (HIMC) 320 that is sandwiched between two dielectric layers 322 and 322′. Similar to HIMC 220 of FIG. 3, HIMC 320, may, according some embodiments, be made of iron, cobalt or nickel, or alloys thereof. According to embodiments of the present invention, the HIMC may have an inductance that is tunable from the pico Henry to the micro Henry range. The dielectric layers may be composed of the same materials as outlined with respect to layers 222 and 222′ of FIG. 3. According to embodiments of the present invention, similar to the coil windings of TFFEI 210 described above, coil windings 328 of TFFEI 310 are provided by a system of conductive traces, such as traces 324 and 324′, and vias that collaborate with vias provided in the device adapted to use the TFFEI, such as vias 340 and 340′ of device 326, and vias 326, 326′, 327 and 327′ of the inductor to form windings 328 about the magnetic core 320, as suggested by way of example in FIG. 4. The traces and vias may include a conductive material such as copper. Similar to the TFFDI of FIG. 2, spaces may be provided between the vias 326 and 326′ and the HIMC of the TFFEI to isolate the vias from the same. Such spaces may include an electrically insulating material 330 therein, such as, for example, B-stage paste in the form of solder paste. In this particular embodiment, the vias are staggered in order to provide improved dimensional contours for the inductor windings, the smoother contours leading to improved performance. In general, staggered via coils advantageously minimize current flow sensitivities to sharp geometric features, hence improving a current carrying capability along the coil.

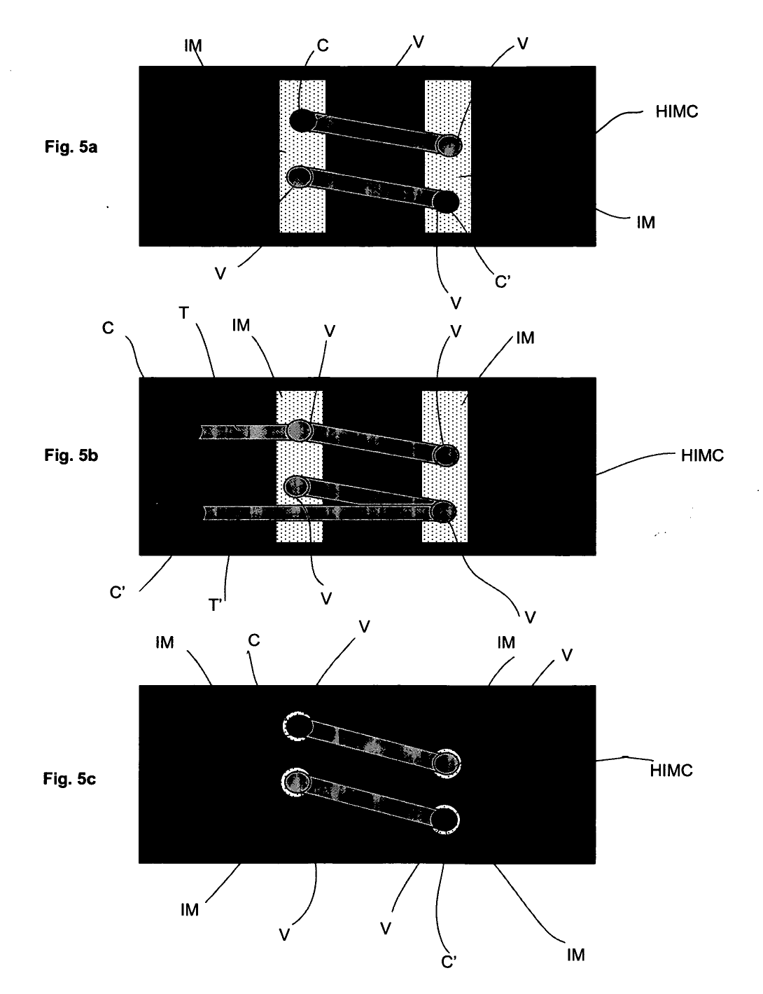

FIGS. 5a, 5b and 5c represent partially cut away top views of three different embodiments of an inductor according to the present invention. In particular, FIGS. 5a, 5b and 5c show three different inductor embodiments in a top view with the layers covering the HIMC, such as, for example, a pre-impregnation layer or a dielectric layer, plus associated traces, as having been removed, thus exposing the HIMC. According to one embodiment, electrical contacts C and C′ to the inductor may be provided directly on the vias V, as shown in FIG. 5a, or connected to the vias V via additional traces T and T′, as shown in FIG. 5b. In addition, electrically insulating material IM, such as electrically insulating material 130, 230 or 330 shown in FIGS. 2, 3 and 4, respectively, may be provided about the vias V in either a space that is rectangular in top plan view, as shown in FIGS. 5a or 5b, or in a space that is round in top plan view, as shown in FIG. 5c. It is to be noted that FIGS. 5a, 5b and 5c show only three of many-possible embodiments for an inductor configuration according to the present invention. Thus, many other electrical contact configurations and electrically insulating material configurations are possible according to embodiments of the present invention, although not necessarily shown in the attached drawings.

An embodiment of a method for making each of the configurations of FIGS. 2, 3 and 4 will be described below.

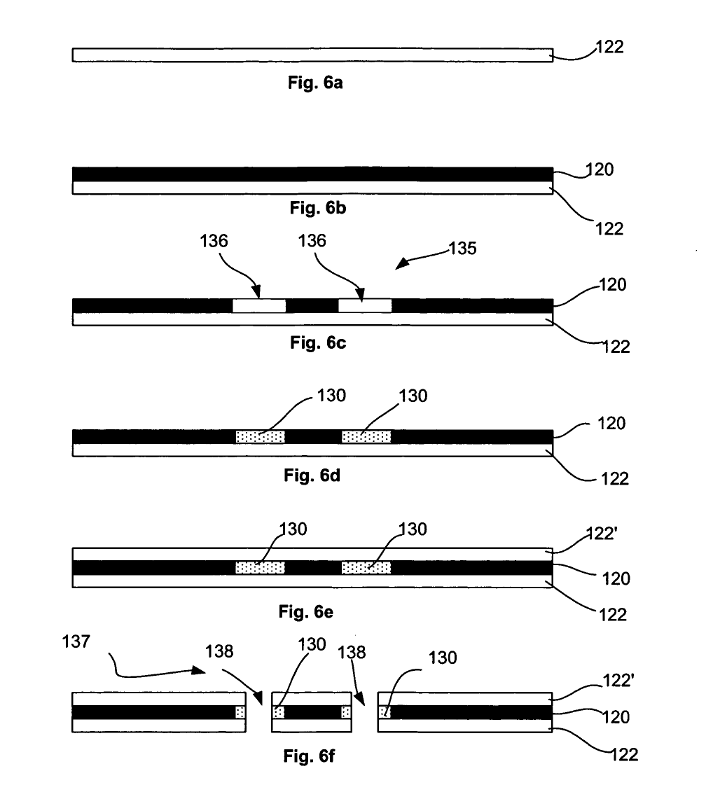

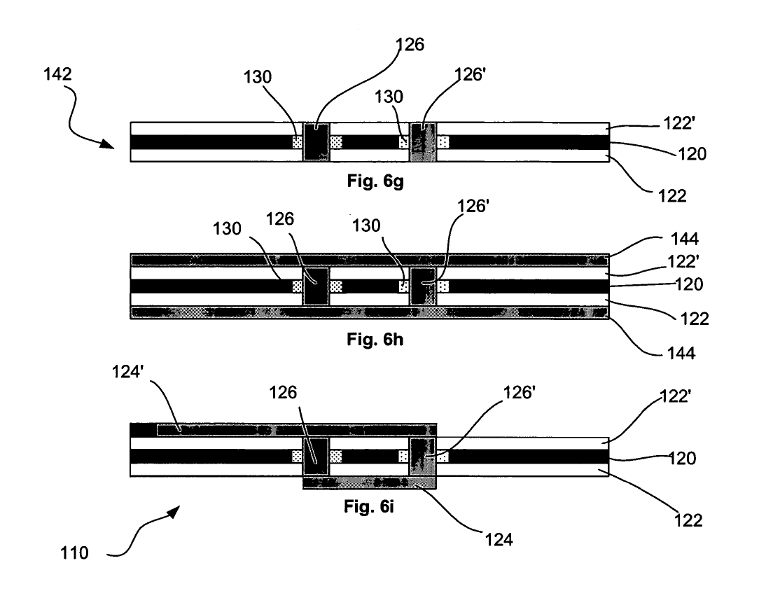

Referring first to FIGS. 6a-6i, a method for making a TFFDI according to an embodiment of the present invention such as the embodiment shown in FIG. 2 will be described.

As seen in FIG. 6a, a first stage of making a TFFDI such as the TFFDI of FIG. 2 involves providing a first pre-impregnation layer, such as first pre-impregnation layer 122. Pre-impregnation layer 122 may be made of reinforced polymer, such as, for example, an epoxy based polymer reinforced with glass fibers and filled with silica particles, and may be provided using lamination. The pre-impregnation layer may be made on any suitable support surface (not shown), such as, for example, a surface made of a core material, such as Cu clad FR4 materials conventionally used in printed circuit board applications. The resulting structure is thus shown in FIG. 6a.

Thereafter, as seen in FIG. 6b, a second stage of making a TFFDI such as the TFFDI of FIG. 2 involves providing a HIMC, such as HIMC 120, on the pre-impregnation layer 122 as shown. HIMC 120 may be made of a soft magnetic material, such as iron, nickel or cobalt, or alloys thereof, and may be provided onto the pre-impregnation layer preferably using lamination, or, in the alternative, using sputtering, electroplating, electroless plating and/or cladding. The resulting structure is thus shown in FIG. 6b.

Referring next to FIG. 6c, a third stage of making TFFDI such as the TFFDI of FIG. 2 involves providing a pattern 135 of spaces 136 in the HIMC adapted to receive electrically insulating material, such as material 130 shown in FIG. 2, therein. The pattern 135 of spaces 136 thus provided may have any suitable configuration, such as, for example a configuration corresponding to any of the patterns of spaces containing the electrically insulating material IM shown in FIGS. 5a, 5b or 5c and described above. Provision of the pattern 135 of spaces 136 may be effected using lithography, such as as wet etch or a dry etch. The resulting structure is thus shown in FIG. 6c.

As seen in FIG. 6d, a subsequent stage of making a TFFDI such as the TFFDI of FIG. 2 involves filling the pattern 135 of spaces 136 with an electrically insulating material 130, such as, for example, B-stage paste, epoxy, or any other suitable electrically insulating material, for example using a squeegee, lamination or sputtering. Insulating material 130 provides electrical isolation of the vias with respect to the HIMC. The resulting structure is shown in FIG. 6d.

Referring next to FIG. 6e, a subsequent stage of making a TFFDI such TFFDI of FIG. 2 involves providing a second pre-impregnation layer, such as pre-impregnation layer 122′, onto HIMC 120. Pre-impregnation layer 122′ may be made of the same material and provided in the same manner as pre-impregnation layer 122. The resulting structure is shown in FIG. 6e.

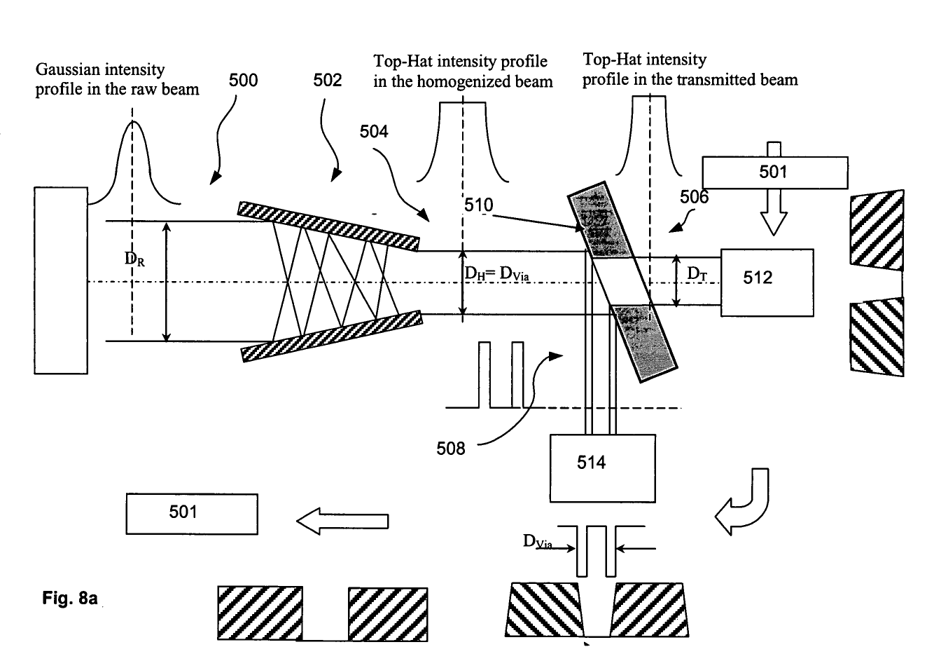

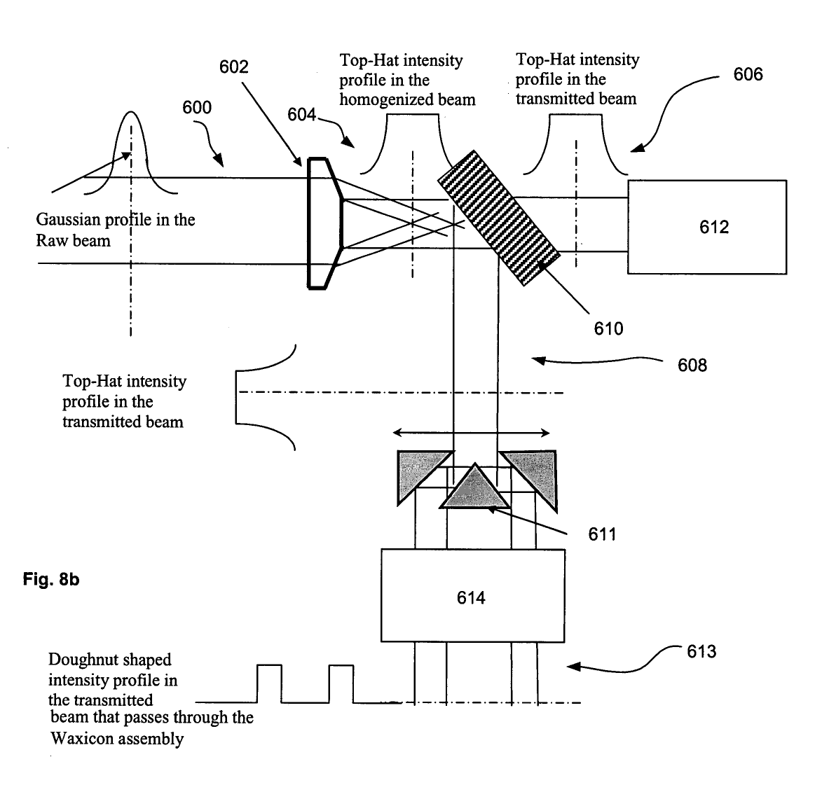

Referring to FIG. 6f, a subsequent stage of making a TFFDI such TFFDI of FIG. 2 involves providing a pattern of via holes extending from a surface of the second pre-impregnation layer to a surface of the first pre-impregnation layer through the electrically insulating material. Thus, according to the shown embodiment of the present invention, a pattern 137 of via holes 138 may be provided to extend from a surface of second pre-impregnation layer 122′ to a surface of the first pre-impregnation layer 122 through the electrically insulating material 130. Via holes 138 may for example be drilled into the structure, such as, for example, by way of laser-drilling or mechanical-drilling. When laser-drilling, a shaped laser beam may be used, as will be explained in further detail in subsequent paragraphs of the instant description. Preferably, laser-drilling with a shaped laser beam is used to create the via holes to improve both throughput and alignment. Further detail regarding laser-drilling the via holes is provided in the paragraphs further below with respect to the laser arrangements of FIGS. 8a and 8b. The resulting structure is shown in FIG. 6f.

In general, there would be two main reasons for choosing laser drilling over mechanical drilling. First, laser drilling allows the use of a shaped laser beam that permits the achievement of a the same device configuration as would be achieved with mechanical drilling, however with faster throughput and better feature alignment accuracy. Second, laser drilling allows the achievement of a staggered via coil configuration that is not possible with mechanical drilling.

As next seen in FIG. 6g, a subsequent stage of making a TFFDI such as TFFDI of FIG. 2 involves providing a conductive material in the via holes, such as providing copper 140 in via holes 138 to make the vias 126 and 126′. The conductive material may be provided for example using methods of electroless plating, electrolytic plating, CVD, and/or collimated or ionized metal sputtering known in the prior art, and planarizing excess conductive material using chemical mechanical polishing. Although copper may be used in the preferred embodiment, other conductive materials, such as aluminum, aluminum-copper alloy, gold and/or silver may be used. The resulting structure 142 is shown in FIG. 6g, which, for the purposes of the instant description, will be referred to as an intermediate inductor structure.

Referring next to FIGS. 6h and 6i, a next stage of making a TFFDI such as TFFDI of FIG. 2 involves providing a pattern of conductive traces on the intermediate inductor structure, the conductive traces being in electrical contact with the vias. For example, intermediate inductor structure 142 of FIG. 6g may be provided with a pattern of conductive traces 124,124′ thereon in contact with vias 126 and 126′. As seen in FIG. 6h, providing a pattern of conductive traces involves providing films 144 of conductive material, such as, for example, copper, aluminum, aluminum-copper alloy, gold and/or silver, on the intermediate inductor structure 142, and thereafter patterning the films 144 using well known processes such as lithography. The resulting structure is shown in FIG. 6i, and corresponds to TFFDI 110 shown in FIG. 2. A TFFDI made according to the method described above in relation to FIGS. 6a-6i may for example be operatively mounted in an arrangement such as die stack up 100 shown in FIG. 1, and may further have a thickness as low as about 3 mils. According to embodiments, a TFFDI made according to method embodiments may have a thickness between about 100 microns and about 300 microns.

Referring next to FIGS. 7a-7k, a method for making a TFFEI according to an embodiment of the present invention, such as the embodiment shown in FIG. 3, will be described.

Referring first to FIG. 7a, a first stage of making a TFFEI such as TFFEI of FIG. 3 involves providing a substrate, which, in the shown embodiment, comprises providing a substrate 234 similar to substrate 116 of FIG. 1.

Referring next to FIG. 7b, a second stage of making a TFFEI such as TFFEI of FIG. 3 involves providing a conductive film on one side of the substrate, which, in the shown embodiment, comprises providing a conductive film 241 on one side of BT layer 234 as shown. Conductive film 241 is made of a conductive material, such as, for example, copper, aluminum, aluminum-copper alloy, gold and/or silver. According to a preferred embodiment, the BT layer 234 may be laminated onto a conductive film 241 or provided onto conductive film 241 via cladding according to any one of well-known methods. The resulting structure is the one shown in FIG. 7b.

Referring next to FIG. 7c, a third stage of making a TFFEI such as TFFEI of FIG. 3 involves providing a first pattern of via holes through the substrate extending up to the conductive film. In the shown embodiment, the third stage involves providing a first pattern 255 of via holes 256 through the substrate 234 extending up to the conductive film 241. Via holes 256 may for example be drilled into the substrate 234, such as, for example, by way of laser drilling or mechanical drilling. Preferably, laser-drilling with a shaped laser beam is used to create the via holes to improve both output and alignment. Further detail regarding laser-drilling the via holes is provided in the paragraphs further below with respect to the laser arrangements of FIGS. 8a and 8b. The resulting structure is shown in FIG. 7c.

As shown in FIGS. 7d, a subsequent stage of making a TFFEI such as TFFEI of FIG. 3 involves providing a conductive material in the via holes, such as providing copper 140 in via holes 138 to make the vias 126 and 126′. The conductive material may be provided for example using methods of electroless plating, electrolytic plating, CVD, and/or collimated or ionized metal sputtering known in the prior art, and planarizing excess conductive material using chemical mechanical polishing. Although copper may be used in the preferred embodiment, other conductive materials, such as aluminum, aluminum-copper alloy, gold and/or silver may be used. The resulting structure is shown in FIG. 7d, which, for the purposes of the instant description, will be referred to as an intermediate device structure.

Referring next to FIGS. 7e-7k, a next stage of making a TFFEI such as TFFEI of FIG. 3 involves providing an intermediate inductor structure on the intermediate device structure.

As seen in FIG. 7e, a first stage of making a TFFEI such as the TFFEI of FIG. 3 involves providing a first dielectric layer on the substrate, such as providing a first dielectric layer 222 on BT layer 234. Examples for the dielectric layer may include ABF, poly-tetrafluoro ethylene (PTFE), polyimide, low-k materials like SiLK, (Manufacturer: The Dow Chemical Company, Midland, Mich.), poly arylenes, cyclotenes, and teflons, and/or polyimide nanofoams. The dielectric layer may be provided for example using lamination. The resulting structure is thus shown in FIG. 7e.

Thereafter, as seen in FIG. 7f, a second stage of making a TFFEI such as the TFFEI of FIG. 3 involves providing a HIMC, such as HIMC 220, on the dielectric layer 222 as shown. HIMC 220 may be made of a soft magnetic material, such as iron, nickel or cobalt, or alloys thereof, and may be provided using lamination onto the dielectric layer. The resulting structure is thus shown in FIG. 7f.

Referring next to FIG. 7g, a third stage of making TFFEI such as the TFFEI of FIG. 3 involves providing a pattern 235 of spaces 236 in the HIMC adapted to receive electrically insulating material, such as material 230 shown in FIG. 3, therein. The pattern 235 of spaces 236 thus provided may have any suitable configuration, such as, for example a configuration corresponding to any of the patterns of spaces containing the electrically insulating material IM shown in FIGS. 5a, 5b or 5c and described above. Provision of the pattern 235 of spaces 236 may be effected using lithography, such as a dry etch. The resulting structure is thus shown in FIG. 7g.

As seen in FIG. 7h, a subsequent stage of making a TFFEI such as the TFFEI of FIG. 3 involves filling the pattern 235 of spaces 236 with an electrically insulating material 230, such as, for example, B-stage paste, epoxy, or any other suitable electrically insulating material, for example using a squeegee, lamination or sputtering. Insulating material 230 provides electrical isolation of the vias with respect to the HIMC. The resulting structure is shown in FIG. 7h.

Referring next to FIG. 7i, a subsequent stage of making a TFFEI such TFFEI of FIG. 3 involves providing a second dielectric layer, such as dielectric layer 222′, onto HIMC 220. Dielectric layer 222′ may be made of ABF, and may be provided using lamination The resulting structure is shown in FIG. 7i. &&

Referring to FIG. 7j, a subsequent stage of making a TFFEI such TFFEI of FIG. 3 involves providing a pattern of via holes extending from a surface of the second dielectric layer through the first dielectric layer and through the electrically insulating material. Thus, according to the shown embodiment of the present invention, a pattern 237 of via holes 239 may be provided to extend from a surface of second dielectric layer 222′ through the first dielectric layer 222 through the electrically insulating material 230. Via holes 238 may for example be drilled into the structure, such as, for example, by way of laser-drilling or mechanical-drilling. When laser-drilling, a shaped laser beam may be used, as will be explained in further detail in subsequent paragraphs of the instant description. Preferably, laser-drilling with a shaped laser beam is used to create the via holes to improve both output and alignment. Further detail regarding laser-drilling the via holes is provided in the paragraphs further below with respect to the laser arrangements of FIGS. 8a and 8b. The resulting structure is shown in FIG. 7j.

As next seen in FIG. 7k, a subsequent stage of making a TFFEI such as TFFEI of FIG. 3 involves providing a conductive material in the via holes, such as providing copper 240 in via holes 238 to make the vias 226 and 226′. The conductive material may be provided for example using methods of electroless plating, electrolytic plating, CVD, and/or collimated or ionized metal sputtering known in the prior art, and planarizing excess conductive material using chemical mechanical polishing. Although copper may be used in the preferred embodiment, other conductive materials, such as aluminum, aluminum-copper alloy, gold and/or silver may be used. The resulting structure is shown in FIG. 7k, which, for the purposes of the instant description, will be referred to as an intermediate inductor structure 243.

Referring next to FIGS. 7l and 7m, a next stage of making a TFFEI such as TFFEI of FIG. 3 involves providing a pattern of conductive traces on the intermediate inductor structure, the conductive traces being in electrical contact with the vias. For example, intermediate inductor structure 243 of FIG. 7k may be provided with a pattern of conductive traces 224, 224′ thereon (FIG. 7m) in contact with vias 226 and 226′. As seen in FIG. 7l, providing a pattern of conductive traces involves providing a film 244 of conductive material to supplement already existing film 241, such as, for example, copper, aluminum, aluminum-copper alloy, gold and/or silver, on the intermediate inductor structure 243, and thereafter patterning the films 241 and 244 using well known processes such as lithography. The resulting structure is shown in FIG. 7m, and corresponds to TFFEI 210 shown in FIG. 3.

With respect to a method of fabricating a TFFEI as seen in FIG. 4, where the vias are staggered, a method similar to that described in relation to FIGS. 7a-7m may be used, except that the laser drilling is effected such that the via holes are staggered relative to one another. In addition, metal traces may be provided between successive via layers according to conventional methods. A preferred manner of providing the staggered vias would be to use a shaped laser beam as described in relation to FIGS. 8a and 8b above. A location of the staggered vias according to an embodiment may be controlled by governing a tool path of the laser drilling machine according to the required device pattern of the package across a panel adapted to support a plurality of such packages.

Advantageously, a TFFDI or TFFEI made according to embodiments of the instant invention, by virtue of the soft magnetic core, generates high inductance (that is, an inductance above about 1 pico Henry for transformer and power supply applications while decreasing package x-y dimensions, the inductor itself having a thickness that can be as low as 100 microns for cost reduction. In addition, to the extent that a TFFDI or a TFFEI according to embodiments of present invention has a high inductance and small size, it may be used in flash memory PSIP application, where, to date, SMT inductors have been used with consequent package size increase and assembly reliability issues.

Additionally, a TFFDI according to embodiments of the present invention advantageously can meet thickness requirements of about 3 mils so that it can be sandwiched as a spacer between two dies, such as two silicon dies. Thus, a TFFDI according to embodiments of the present invention advantageously allows the formation of an organic discrete inductor without the need to embed the inductor in a substrate, which can be costly.

With respect to laser drilling via holes, preferred methods according to the present invention are described below with respect to FIGS. 8a and 8b.

According to preferred embodiments, a new optical path design may be provided in laser drilling the via holes in order to manipulate the laser beam. It is applicable for both the current CO₂ laser technology as well as any future laser technology such as; IR-YAG, visible-YAG, UV-YAG, CVL and Excimer lasers. Preferred embodiments of laser drilling according to the present invention aim at controlling via geometry in order to decrease via tapering, wall charring and hence increase via reliability. Laser drilling embodiments according to the present invention may be implemented according to two versions described below.

According to the first version, referring to FIG. 8a, a raw laser beam 500 (that is, a laser beam emitted from the lasing cavity) may first be homogenized in a beam homogenizer such as a refractive, two-plate homogenizer in the form of a kaleidoscope integrator 502 to produce a top hat beam 504 with a uniform intensity distribution (as opposed to a Gaussian distribution). Beam homogenization can also be achieved by passing the originally Gaussian profile into either a transmissive integrator, a strip reflective integrator or a diffractive diffuser. The homogenized laser beam 504 may have a fluence that is higher than the ablation threshold of the panel 501 to be provided with via holes. The homogenized beam 504 may then be split into two beams 506 and 508 using a hole reflective beam splitter 510. Of these two beams, beam 506 may have a top-hat intensity distribution, a fluence higher than the ablation threshold of the material to be provided with holes and a beam diameter slightly smaller than a via diameter of the vias to be provided. The second beam 508 may have a doughnut shaped intensity distribution, a ring width equal to the difference between the via diameter and the first-top hat beam diameter, and may possess a fluence higher than the ablation threshold of the panel to be provided with via holes. Each of the two beams 506 and 508 may be driven by a separate galvanometer 512 and 514, respectively. The process sequence is designed such that the panel to be provided with vias first goes under the top-hat beam 506 to drill vias with a diameter smaller than the final via diameter. The panel then passes to the second beam 508 so that its diameter is widened to the required value and its wall straightened.

Preferably, according to embodiments of the present invention, with respect to laser drilling, the raw beam 500 may be produced with sufficient intensity that equal to the summation of the top hat beam 500's intensity, the doughnut beam 508's intensity and the losses through the optical elements (i.e., the homogenizer single hole splitter and galvanometers mirrors). The raw beam intensity may be so chosen that the top hat and the doughnut shaped beams individually possess fluence that is higher than the ablation threshold of the panel to be provided with via holes. In addition, the temporal distribution of the raw beam 500 may be square in shape to maximize the utilized photon energy and minimize the heat affected zone within the panel to be provided with via holes. Moreover, the pulse width may be longer than the time needed to ablate the required volume of the panel to be provided with via holes.

According to the second version, referring to FIG. 8b, a homogenized beam 604 formed by a homogenizer 602 from a raw beam 600 may be split, using a fifty-fifty beam splitter 610; into two top-hat beams 606 and 608. One beam 606 may be used directly to drill a via with a diameter smaller than the required one. The other beam may be expanded then passed through a Waxicon or Axicon optics 611 to obtain a doughnut shaped intensity distribution 613. In this version each of the two beams is driven independently by a galvanometer 612 and 614, respectively, to allow for two-panels drilling. The intensity requirements for the raw beam used in this version may be identical to that stated in the paragraph above with respect to FIG. 8a.

Additionally, in case the laser machine cannot produce the beam to meet the above mentioned intensity requirements, according to embodiments, two laser machines may be used such that one produces the top-hat beam and the other produces the doughnut-shaped one. Additionally, it is noted that for any of the above mentioned versions, the sequence of via drilling may be as follows. First a via may be drilled using the top hat beam with a diameter smaller than the required via diameter, then the doughnut shaped beam may be used to widen the diameter to its final value and to straighten the via wall.

The above proposed manner of providing laser-drilled vias according to preferred embodiments provides a new optical path design of the laser beam used in via drilling. This allows control of the laser beam shape and temporal characteristics in order to control the laser-dielectric material interaction (isotherm distribution) and hence control via geometry. Using laser-drilling as noted above according to preferred embodiments would not require a significant variation in the current manufacturing tools.

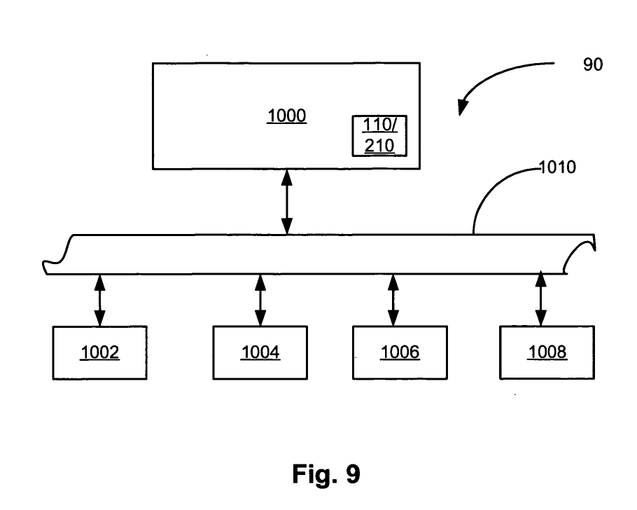

Referring to FIG. 9, there is illustrated one of many possible systems in which embodiments of the present invention may be used. The electronic assembly 1000 may include a TFFDI such as TFFDI 110 of FIG. 2, or a TFFEI, such as TFFEI 210 of FIG. 3. In one embodiment, the electronic assembly 1000 may include a microprocessor. In an alternate embodiment, the electronic assembly 1000 may include an application specific IC (ASIC). Integrated circuits found in chipsets (e.g., graphics, sound, and control chipsets) may also be packaged in accordance with embodiments of this invention.

For the embodiment depicted by FIG. 9, the system 90 may also include a main memory 1002, a graphics processor 1004, a mass storage device 1006, and/or an input/output module 1008 coupled to each other by way of a bus 1010, as shown. Examples of the memory 1002 include but are not limited to static random access memory (SRAM) and dynamic random access memory (DRAM). Examples of the mass storage device 1006 include but are not limited to a hard disk drive, a compact disk drive (CD), a digital versatile disk drive (DVD), and so forth. Examples of the input/output module 1008 include but are not limited to a keyboard, cursor control arrangements, a display, a network interface, and so forth. Examples of the bus 1010 include but are not limited to a peripheral control interface (PCI) bus, and Industry Standard Architecture (ISA) bus, and so forth. In various embodiments, the system 90 may be a wireless mobile phone, a personal digital assistant, a pocket PC, a tablet PC, a notebook PC, a desktop computer, a set-top box, a media-center PC, a DVD player, and a server.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A microelectronic inductor comprising:
a pair of supporting layers;
a high inductance soft magnetic core disposed between the supporting layers; and
conductive windings provided about the magnetic core, the windings including a system of interconnected conductive vias and conductive traces, the vias extending through the supporting layers and the magnetic core and the conductive traces being disposed to interconnect the vias.

2. The microelectronic inductor of claim 1, wherein the magnetic core comprises one of iron, cobalt, nickel and alloys thereof.

3. The microelectronic inductor of claim 1, wherein the vias extend through the supporting layers and through the magnetic core in one of a straight manner and a staggered manner.

4. The microelectronic inductor of claim 1, further comprising an electrically insulating material disposed to electrically insulate the vias from the magnetic core.

5. The microelectronic inductor of claim 1, wherein the windings include one of copper, aluminum, an aluminum-copper alloy, gold and silver.

6. The microelectronic inductor of claim 1, wherein the inductor has a thickness between about 100 microns to about 300 microns.

7. The microelectronic inductor of claim 1, wherein the inductor is a discrete inductor configured to be operatively mounted in a microelectronic arrangement.

8. The microelectronic inductor of claim 1, wherein the pair of supporting layers comprises a pair of pre-impregnated layers.

9. The microelectronic inductor of claim 8, wherein each of the pre-impregnated layers comprises an epoxy-based polymer, glass fibers reinforcing the polymer, and silica particles filling the polymer.

10. A microelectronic assembly comprising:
a microelectronic device; and
an embedded inductor assembly operatively connected to the microelectronic device and including a substrate and an inductor patterned on the substrate, the inductor comprising:
a pair of supporting layers;
a high inductance soft magnetic core disposed between the supporting layers; and
conductive windings provided about the magnetic core, the windings including a system of interconnected conductive vias and conductive traces, the vias extending through the supporting layers, the magnetic core and the substrate, and the conductive traces being disposed to interconnect the vias.

11. The microelectronic inductor of claim 10, wherein the pair of supporting layers comprises a pair of dielectric layers.

12. The microelectronic inductor of claim 11, wherein each of the dielectric layers is made of ABF.

13. The microelectronic inductor of claim 10, wherein the substrate is made of bismaleimide triazine.

14. The microelectronic inductor of claim 10, wherein the microelectronic device is one of a flash memory device, and a voltage regulator.

15. A method of fabricating a microelectronic inductor comprising:
providing a high inductance soft magnetic core between a pair of supporting layers;
providing conductive windings around the magnetic core, the windings including a system of interconnected conductive vias and conductive traces, the vias extending through the supporting layers and the magnetic core, and the conductive traces being disposed to interconnect the vias.

16. The method of claim 15, wherein:
providing a high inductance magnetic core comprises:
providing a first one of the pair of supporting layers;
providing the magnetic core onto the first one of the supporting layers;
providing a second one of the pair of supporting layers; and
providing conductive windings comprises:
providing via holes, each of the via holes extending through the pair of supporting layers and the magnetic core;
providing a conductive material in the via holes to create the vias;
providing the conductive traces to interconnect the vias.

17. The method of claim 16, wherein providing the magnetic core onto the first one of the supporting layers comprises laminating the magnetic core onto the first one of the supporting layers.

18. The method of claim 16, wherein providing a second one of the pair of supporting layers comprising laminating the second one of the pair of supporting layers onto the magnetic core.

19. The method of claim 16, wherein providing via holes comprises using one of mechanical drilling and laser drilling to provide the via holes.

20. The method of claim 19, wherein using laser drilling comprises using a shaped laser beam to provide the via holes.

21. The method of claim 16, wherein providing the conductive material comprises at least one of electroless plating and electrolytic plating of the conductive material.

22. The method of claim 16, wherein providing the conductive traces comprises providing films of conductive material to be in contact with the vias, and patterning the films of conductive material.

23. The method of claim 15, further comprising providing a substrate of a microelectronic device and patterning the inductor on the substrate.

24. The method of claim 23, wherein the conductive traces comprise first conductive traces on a surface of the substrate, and second conductive traces on a surface of the second supporting layer.

25. The method of claim 15, wherein the pair of supporting layers comprise a dielectric material.

26. The method of claim 15, wherein the magnetic core comprises one of iron, cobalt, nickel and alloys thereof.

27. A system including:
an inductor comprising:
a pair of supporting layers;
a high inductance soft magnetic core disposed between the supporting layers; and
conductive windings provided about the magnetic core, the windings including a system of interconnected conductive vias and conductive traces, the vias extending through the supporting layers, the magnetic core, and the conductive traces being disposed to interconnect the vias; and
a memory device operatively coupled to the inductor.

28. The system of claim 27, wherein the memory device is a flash memory device.

29. The system of claim 27, wherein the inductor is one of a discrete inductor connected to the memory device and an embedded inductor patterned on a substrate.
